(19) United States
(12) Patent Application Publication
(10) Pub. No.: US 2026/0119373 A1
(43) Pub. Date: Apr. 30, 2026

(54) SYSTEMS AND METHODS FOR AUTOMATED GENERATION OF SOFTWARE APPLICATION TESTS

(71) Applicant: SAP SE, Walldorf (DE)

(72) Inventors: Veeraswamy Ekambaram, Chennai (IN); Senthilnathan K, Cuddalore (IN); Sachin Kumar, Bangalore (IN); Shantanu Garg, Bengaluru (IN); Priyadarsana Panda, Bangalore (IN)

(21) Appl. No.: 18/930,463

(22) Filed: Oct. 29, 2024

(51) Int. Cl. G06F 11/36

(52) U.S. Cl. CPC G06F 11/3684

(57) ABSTRACT

Embodiments of the present disclosure include techniques for automatically generating enterprise application test scripts. In one embodiment, process flows are retrieved from a software system. Task data for the process flows is extracted and converted into one or more JSON objects. The JSON objects are sent to an LLM to autogenerate test scripts. The test scripts are executed by a software test system to test the enterprise application.

### BACKGROUND

The present disclosure relates generally to software application test automation, and in particular, to systems and methods for automated generation of software application tests.

In general, and in the context of enterprise software applications, a comprehensive manual testing effort is crucial to guarantee the safeguarding of existing functionalities and business processes whether it involves new installations, conversions, updates, upgrades or rollouts. There is a significant effort needed for defining the right scope, developing automation scripts, executing tests, and importantly, maintaining the automated lifecycle. Defining the right scope and developing and sustaining a robust automated regression suite requires complex interaction with the enterprise system to extract precisely the correct information needed to generate tests.

Accordingly, automated generation of software application test automation scripts is a technical problem. The present disclosure is directed at techniques that provide a technical solution to this problem.

### BRIEF DESCRIPTION OF THE DRAWINGS

FIG. 1 illustrates a system for performing automated software test generation according to an embodiment.

FIG. 2 illustrates a method performing automated software test generation according to an embodiment.

FIG. 3A illustrates an example process flow according to an embodiment.

FIG. 3B illustrates an example query for retrieving process variants according to an embodiment.

FIG. 4A illustrates task data according to an embodiment.

FIG. 4B illustrates transactions in a JSON format according to an embodiment.

FIG. 4C illustrates a test script according to an embodiment.

FIG. 5 illustrates hardware of a special purpose computing system configured according to the above disclosure.

### DETAILED DESCRIPTION

Described herein are techniques for performing automated machine learning. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

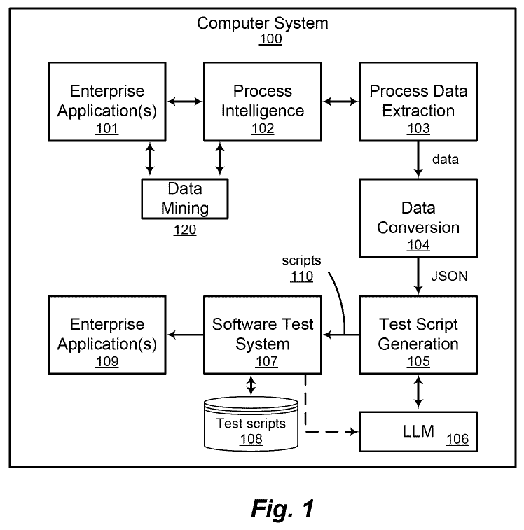

FIG. 1 illustrates a computer system 100 configured to perform automated test generation according to an embodiment. Computer system may comprise one or more processors, memory, a network interface, and one or more buses for communicating information between the various components. In various embodiments, computer system 100 may be a physical computer system or a virtual computer system. In some embodiments, computer system 100 may comprise multiple backend server systems for executing software in a data center (e.g., either a private data center or a public cloud data center).

Software according to various embodiments performs a computer implemented method performing automated software test generation. First, a component of process data extraction software block 103 retrieves a plurality of process flows from one or more applications. Applications may be part of an enterprise application software system 101 comprising multiple software applications performing different functionality. Each different applications may perform a number of different software processes (process flows) for a wide variety of functions (e.g., resource planning, supply chain, financial management, human resource management, and many others). Accordingly, enterprise applications 101 may comprise many predefined process flows for carrying out various functions (e.g., purchasing, requisition, invoice processing, employee management, etc.). Process flows may be defined and stored in the enterprise applications as data and metadata, for example. Different process flows may have associated data and metadata specific to each process flow, including a unique process flow identification (ID), for example.

In some instances, a particular process may have a number of variants. Variant processes are process flows relating to a same job or function (e.g., purchasing) that may be carried out in slightly different ways (e.g., the start and end points are substantially the same, but one or more tasks required to complete the process may be different). For example, one purchasing process flow may require certain steps/tasks. However, another purchasing flow may have a particular additional step/tasks due to a unique relationship between the buyer and seller (e.g., a unique contract term that requires additional computerized steps). In some situations, an application may have a large number of process flow variants, which makes automated test generation a challenge. It can be technically challenging to generate tests automatically when the process flows being tested have a variety of deviations. To overcome this technical problem, embodiments of process data extraction 103 may determine a top N process flows of the plurality of process flows. The top N process flows may be the top N most frequently used process flows for the category of processes. The top N most frequently used process flows may be variant processes for performing a particular job. As described in more detail below, selecting variant process flows with a high usage enables automated generation of test automation scripts (aka, test scripts) due to the more abundant availability of data relating to such flows.

A software component in process data extraction 103 may be configured to extract task data (e.g., using the process flow IDs) for each of the plurality of process flows retrieved from the enterprise applications 101. For example, extracting may comprise retrieving a process flow ID for each of the plurality of process flows and using the process flow ID to retrieve task data for each particular process from one or more applications. Task data for each process flow may define the transactions carried out by the computer system to perform the process flow. Each process flow may comprise many transactions, which form the task data for the process flow, for example. As illustrated in examples below, transactions for a process flow may comprise transactions a process identification, an activity, a description, a code fragment, and a module name. In some embodiments, extracting the task data for the process flows comprises communicating with a data mining software system 120. Data mining software system 120 may be configured to retrieve data from the applications 101. For example, using a process flow ID, process intelligence system 102 may interface with the data mining system 120 to gather additional data (e.g., task data) about each particular process, thereby gathering the transactions for each process flow (e.g., activity, description, code fragments, and modules). More specifically, if a process flow includes a step where a user invokes a user interface element, process intelligence 102 and/or data mining system 120 may discover data or metadata in enterprise application 101 relating to the UI element being invoked and return such information as a particular transaction in the process, for example. Accordingly, process data extraction system 103 outputs retrieved data about a number of process flows and tasks and transactions associated with each process flow to define the underlying computational elements of each process flow.

Data conversion component 104 converts the task data into one or more JSON objects. For example, a particular process flow may include a number of transactions. Process flows for the top N most frequently used process flows for a particular job (e.g., purchasing, invoicing, supply chain requisitions, etc.) may include transaction information that may overlap or even be substantially similar with certain variations in the transactions, for example. Each transaction in a process flow may be organized as a related grouping of attributes in a JSON object, for example, where each grouping contains the same attributes with different values (e.g., process flow ID=<process ID value>, activity=<activity value>, description=<description value>, detail=<code fragment>, module name=<module name>). An example JSON object is illustrated below.

Next, the JSON information is received in test script generation component 105. Test script generation component 105 sends the received JSON objects to a large language model (LLM) or LLM based component 106. In one embodiment, LLM 106 is a generative artificial intelligence (AI) system, such as OpenAI, for example, configured to generate scripts for a particular software test system 107, such as Tricentis, for example. In some embodiments, software test system 107 may store a plurality of test automation scripts in a repository 108. The test automation scripts in repository 108 may be integrated into LLM 106 (e.g., used to train the LLM to produce predicted output scripts based on the JSON inputs) or an LLM based component (e.g., to take reference from existing scripts). Accordingly, a custom LLM or LLM based component 106 may be used to process the JSON objects based, at least in part, on the plurality of test automation scripts in repository 108. Software test automation system 107 (aka, software test system) receives test scripts for the process flows generated by the LLM or LLM based component. Software test system may then execute the test scripts to test the processes in the enterprise applications 109. Enterprise applications 109 may run in a test environment, where new features and functions of the applications are tested, and enterprise applications 101 may be running in a production environment or copy of a production environment, for example. Returning to the example where transactions of a process flow specify a user interface element, and one of the output test scripts may cause the user interface element to be invoked during a test on a backend server running the enterprise applications 109, for example.

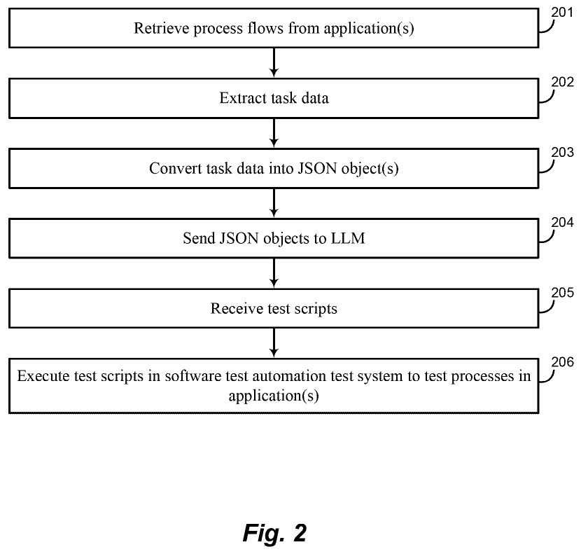

FIG. 2 illustrates a method performing automated software test generation according to an embodiment. At 201, process flows are retrieved from one or more applications, which may be applications in an enterprise software system. In some embodiments, extracting process flows may include determining a top N most frequently used variant process flows for performing a particular job. At 202, task data for certain process flows is extracted. Extracting task data may include retrieving a process ID for each of the process flows and using the process ID to retrieve the task data from the applications. Task data may comprise, for each process flow, a plurality of transactions forming a particular process flow of the plurality of process flows. Transactions forming a particular process may comprise a process identification, a description, an activity, a code fragment, and a module name. At 203, task data is converted into JSON objects. The JSON objects may comprise attribute-value pairs for process identification, a description, an activity, a code fragment, and a module name. At 204, the JSON objects are sent to an LLM. As mentioned above, test automation scripts may be stored in a repository of a software test system and the test automation scripts in the repository are integrated into the LLM. Accordingly, the LLM processes the JSON objects based on the previously stored and predefined test automation scripts to autogenerate new test scripts for testing the applications. At 205, generated test scripts for testing the retrieved process flows are received from the LLM. At 206, the test scripts may be executed in a software test automation system to test the processes in the applications.

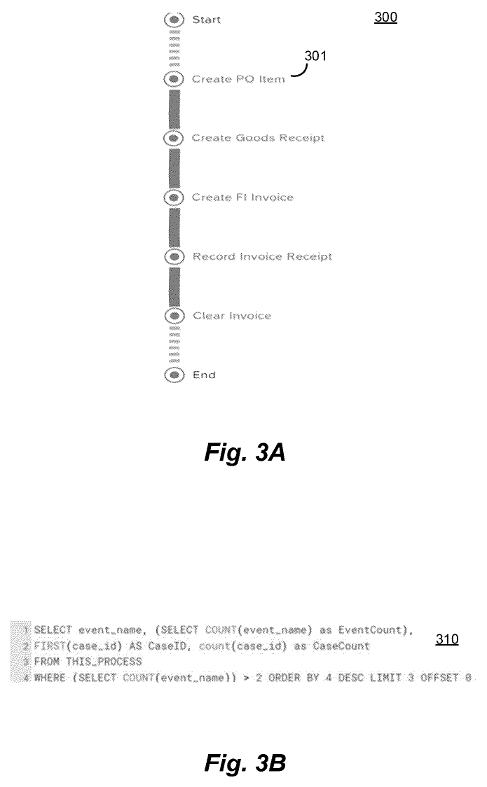

FIG. 3A illustrates an example process flow according to an embodiment. This example process flow 300 involves invoice processing. The first task is to create a PO at 301. Other tasks may include creating a goods receipt, creating an invoice, recording an invoice receipt, and clearing the invoice, for example. Each task of the process flow 300 may comprising one or more underlying computational transactions. Embodiments of the present disclosure may retrieve process flow 300 and a process flow ID, and use information about the process flow to extract underlying information about the tasks and transaction details for the process flow.

FIG. 3B illustrates an example query 310 for retrieving process variants according to an embodiment. Extraction may include automatically generating a query to retrieve transaction information mentioned above. Query 310 is used to extract top 3 frequently used process flow variants. Here, ‘case_id’ refers to unique ID of each process flow. Each process flow is a sequence of transactions which are referred as ‘event_name’ (e.g., As per FIG. 3A—Create PO Item, Create Good Receipt, Create FI Invoice, Record Invoice Receipt and Clear Invoice are sequence of events (‘event_name’) that make out one process flow with unique ‘case_id’). The query variable ‘EventCount’ will extract the number of ‘event_name’ (transactions) present in the process flow. The query variable ‘CaseCount’ used to aggregate the query result in descending order based on number of matching events process flows and limiting to top 3 process flow variants.

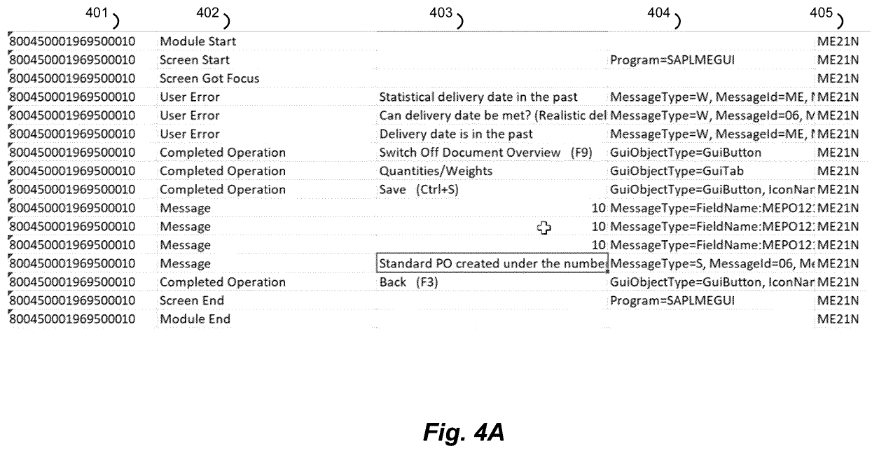

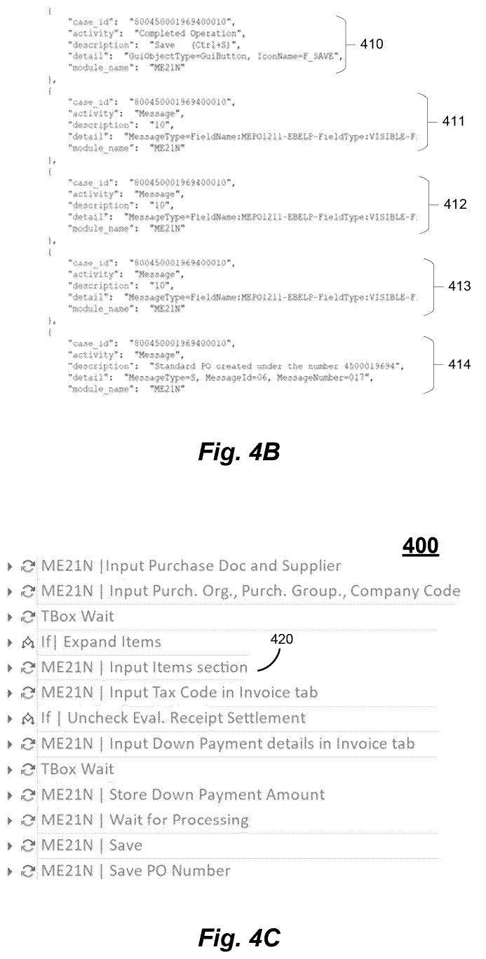

FIG. 4A illustrates task data according to an embodiment. Task data may include a plurality of transaction activities illustrated here as rows of a table, where each row is a different transaction activity. Transaction activities may have attributes, which are the columns of the table in FIG. 4A. Attributes include a process flow ID 401, activity 402, description 403 (if any), a code fragment 404, and a transaction name 405. Column 405 shows the transaction ID, multiple rows in FIG. 4A can make out a transaction (e.g., ME21N) and multiple transactions can make out one process flow (case_id). Column 401 is the unique ‘case_id’ of a process flow (e.g., 800450001969400010). Column 402 shows the type of activity (User action) the User performed during the transaction and Column 403 shows the description of the activity. Column 404 shows the technical details of the UI element the User interacted during the transaction

FIG. 4B illustrates transactions in a JSON format according to an embodiment. Here, a JSON object is created where attributes for the transaction activities are grouped. For example, a transaction activity 410 comprises attribute-value pairs for case id (process flow ID), activity description, description, details (code fragment), and transaction name. Similarly, other transaction activities 411-414 include attribute value pairs that define each transaction. Transaction activities 410, 411, 412, 413, 414 in JSON represents each activity performed by the User with its details. Multiple activity steps combined to form one transaction (e.g., ME21N) and multiple transactions combine to form one process flow with unique case_id. All these activities, transactions, and process flow details are extracted and converted to JSON to pass to next stage of script generation. Advantageously, linking transactions to process flows and defining the transactions using the same attributes allows an LLM, trained with predefined test scripts, to generate new test scripts for testing process flows based on the input JSON object representations of the process flows and task data.

FIG. 4C illustrates a test script according to an embodiment. This example test script may be in a format for a particular software test automation system (aka “test system”). Since the LLM incorporated predefined scripts from the test system, the LLM is able to generate test scripts in the test systems format. Test script 400 shows the automated test steps with respect to each activity (User action) involved in one transaction ME21N. Sequence of multiple transactions form one process flow. Step “ME21N|Input Purchase Doc and Supplier” performs the action of entering Purchase Doc type and Supplier number in the respective UI elements of the application. Step “ME21N|Input Purch. Org., Purch. Group., Company Code” enter other inputs values of the transaction such as Purchasing Organization, Purchasing Group and Company Code. Step “If | Expand Items” expands the item section to enter details. Step 420 “ME21N|Input Items section” enter the items details such as Material, Quantity & Plant as the inputs for this transaction. Finally, the step “ME21N|Save PO Number” save the transaction, verify for success message to ensure the test is passed and record the generated purchase order number.

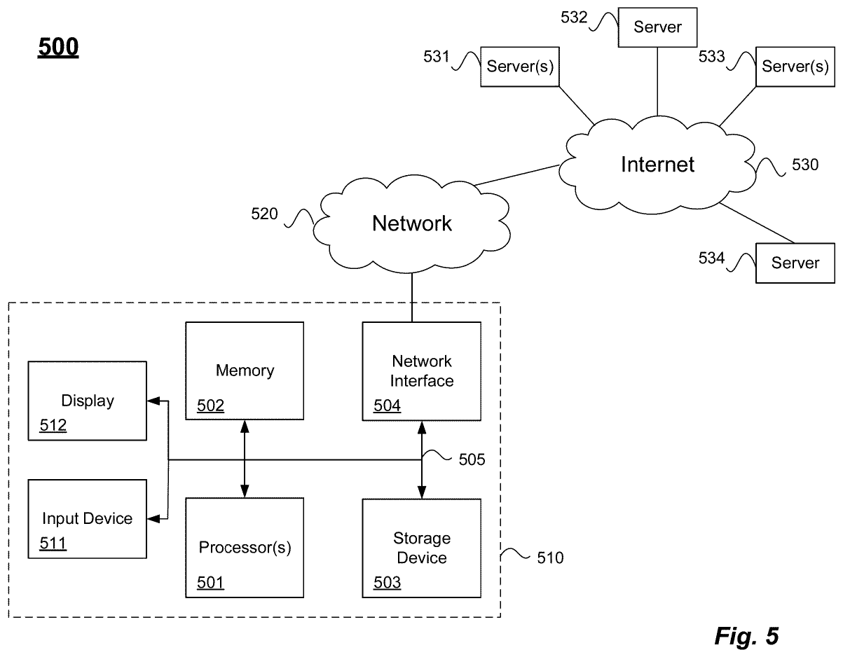

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method performing automated software test generation comprising: retrieving, by a first software component, from one or more applications, a plurality of process flows; extracting, by a second software component, task data for each of the plurality of process flows, said extracting comprising retrieving a process identification for each of the plurality of process flows and using the process identifications to retrieve the task data from the applications, wherein the task data comprises, for each process flow, a plurality of transactions forming a particular process flow of the plurality of process flows; converting the task data into one or more JSON objects; sending the one or more JSON objects to a large language model; receiving, from the large language model, a plurality of test scripts for the plurality of process flows; and executing the plurality of test scripts in a software test automation system to test the plurality of processes in the one or more applications.

In one embodiment, the application is part of an enterprise application software system.

In one embodiment, the method further comprising determining a top N process flows of the plurality of process flows.

In one embodiment, the top N process flows of the plurality of process flows are the top N most frequently used process flows for the category of processes.

In one embodiment, the plurality of process flows are variant processes for performing a particular job.

In one embodiment, one or more transactions of the plurality of transactions forming a particular process comprise a plurality of transaction activities, the transaction activities comprising a process identifications, an activity name, a code fragment, and a transaction name, and wherein the one or more JSON objects specify the process identifications, the activity, the code fragment, and the transaction name for the plurality of transactions.

In one embodiment, the method further comprising: storing a plurality of test automation scripts in a repository; integrating the test automation scripts in the repository into the large language model; and processing the one or more JSON objects based, at least in part, on the plurality of test automation scripts using the large language model.

In one embodiment, extracting the task data for each of the plurality of process flows comprises communicating, by the second software component, with a data mining software system, wherein the data mining software system is configured to receive data from the one or more applications.

In one embodiment, one or more the plurality of transactions specify a user interface element, and wherein at least one of the plurality of test scripts causes the user interface element to be invoked during a test on a backend server running the one or more applications.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method performing automated software test generation comprising:
retrieving, by a first software component, from one or more applications, a plurality of process flows;
extracting, by a second software component, task data for each of the plurality of process flows, said extracting comprising retrieving a process identification for each of the plurality of process flows and using the process identifications to retrieve the task data from the applications, wherein the task data comprises, for each process flow, a plurality of transactions forming a particular process flow of the plurality of process flows;
converting the task data into one or more JSON objects;
sending the one or more JSON objects to a large language model;
receiving, from the large language model, a plurality of test scripts for the plurality of process flows; and
executing the plurality of test scripts in a software test automation system to test the plurality of processes in the one or more applications.

2. The method of claim 1, wherein the application is part of an enterprise application software system.

3. The method of claim 1, further comprising determining a top N process flows of the plurality of process flows.

4. The method of claim 3, wherein the top N process flows of the plurality of process flows are the top N most frequently used process flows for the category of processes.

5. The method of claim 4, wherein the plurality of process flows are variant processes for performing a particular job.

6. The method of claim 1, wherein one or more transactions of the plurality of transactions forming a particular process comprise a plurality of transaction activities, the transaction activities comprising a process identifications, an activity name, a code fragment, and a transaction name, and wherein the one or more JSON objects specify the process identifications, the activity, the code fragment, and the transaction name for the plurality of transactions.

7. The method of claim 1, further comprising:
storing a plurality of test automation scripts in a repository;
integrating the test automation scripts in the repository into the large language model; and
processing the one or more JSON objects based, at least in part, on the plurality of test automation scripts using the large language model.

8. The method of claim 1, wherein extracting the task data for each of the plurality of process flows comprises communicating, by the second software component, with a data mining software system, wherein the data mining software system is configured to receive data from the one or more applications.

9. The method of claim 1, wherein one or more the plurality of transactions specify a user interface element, and wherein at least one of the plurality of test scripts causes the user interface element to be invoked during a test on a backend server running the one or more applications.

10. A computer system comprising:
at least one processor;
at least one non-transitory computer-readable medium storing computer-executable instructions that, when executed by the at least one processor, cause the computer system to perform a method comprising:
retrieving, by a first software component, from one or more applications, a plurality of process flows;
extracting, by a second software component, task data for each of the plurality of process flows, said extracting comprising retrieving a process identification for each of the plurality of process flows and using the process identifications to retrieve the task data from the applications, wherein the task data comprises, for each process flow, a plurality of transactions forming a particular process flow of the plurality of process flows;
converting the task data into one or more JSON objects;
sending the one or more JSON objects to a large language model;
receiving, from the large language model, test scripts for the plurality of process flows; and
executing the plurality of test scripts in a software test automation system to test the plurality of processes in the one or more applications.

11. The computer system of claim 10, wherein the application is part of an enterprise application software system.

12. The computer system of claim 10, further comprising determining a top N process flows of the plurality of process flows, wherein the top N process flows of the plurality of process flows are the top N most frequently used process flows for the category of processes, and wherein the plurality of process flows are variant processes for performing a particular job.

13. The computer system of claim 10, one or more transactions of the plurality of transactions forming a particular process comprise a plurality of transaction activities, the transaction activities comprising a process identifications, an activity name, a code fragment, and a transaction name, and wherein the one or more JSON objects specify the process identifications, the activity, the code fragment, and the transaction name for the plurality of transactions.

14. The computer system of claim 10, further comprising:
storing a plurality of test automation scripts in a repository;
integrating the test automation scripts in the repository into the LLM; and
processing the one or more JSON objects based, at least in part, on the plurality of test automation scripts.

15. A non-transitory computer-readable medium storing computer-executable instructions that, when executed by at least one processor, perform a method comprising:
retrieving, by a first software component, from one or more applications, a plurality of process flows;
extracting, by a second software component, task data for each of the plurality of process flows, said extracting comprising retrieving a process identification for each of the plurality of process flows and using the process identifications to retrieve the task data from the applications, wherein the task data comprises, for each process flow, a plurality of transactions forming a particular process flow of the plurality of process flows;
converting the task data into one or more JSON objects;
sending the one or more JSON objects to a large language model;
receiving, from the large language model, test scripts for the plurality of process flows; and
executing the plurality of test scripts in a software test automation system to test the plurality of processes in the one or more applications.

16. The non-transitory computer-readable medium of claim 15, wherein the application is part of an enterprise application software system.

17. The non-transitory computer-readable medium of claim 15, further comprising determining a top N process flows of the plurality of process flows, wherein the top N process flows of the plurality of process flows are the top N most frequently used process flows for the category of processes, and wherein the plurality of process flows are variant processes for performing a particular job.

18. The non-transitory computer-readable medium of claim 15, wherein the one or more transactions of the plurality of transactions forming a particular process comprise a plurality of transaction activities, the transaction activities comprising a process identifications, an activity name, a code fragment, and a transaction name, and wherein the one or more JSON objects specify the process identifications, the activity, the code fragment, and the transaction name for the plurality of transactions.

19. The non-transitory computer-readable medium of claim 15, further comprising:
storing a plurality of test automation scripts in a repository;
integrating the test automation scripts in the repository into the LLM; and
processing the one or more JSON objects based, at least in part, on the plurality of test automation scripts.

20. The non-transitory computer-readable medium of claim 15, wherein extracting the task data for each of the plurality of process flows comprises communicating, by the second software component, with a data mining software system, wherein the data mining software system is configured to receive data from the one or more applications.
